(19) United States
(12) Patent Application Publication
(10) Pub. No.: US 2012/0311472 A1
(43) Pub. Date: Dec. 6, 2012

(54) APPARATUS AND METHOD FOR PROVIDING GRAPHICAL USER INTERFACE

(75) Inventor: Hyoung-Jin KIM, Seoul (KR)

(73) Assignee: PANTECH CO., LTD., Seoul (KR)

(21) Appl. No.: 13/224,797

(22) Filed: Sep. 2, 2011

(30) Foreign Application Priority Data
Jun. 2, 2011 (KR) 10-2011-0053492

(51) Int. Cl. G06F 3/048

(52) U.S. Cl. 715/765

(57) ABSTRACT

An apparatus and method for providing a graphical user interface (GUI) provide a GUI based on a shelf region that allows one or more graphical objects to be selected or executed on the same display level as one or more graphical objects that are displayed on a background screen. The apparatus includes a first region configured to display one or more graphical objects; a second region configured to be generated by a user setting as an M×N region; and a control unit configured to add one or more of the graphical objects to the second region and to, in response to the number of graphical objects added to the second region being N or greater, display the added graphical objects so that the added graphical objects can be selected, executed, or navigated by a flick or touch gesture that is made in the second region.

### CROSS-REFERENCE TO RELATED APPLICATION(S)

This application claims priority from and the benefit under 35 U.S.C. §119(a) of Korean Patent Application No. 10-2011-0053492, filed on Jun. 2, 2011, which is hereby incorporated by reference for all purposes as if fully set forth herein.

### BACKGROUND

1. Field

The following description relates to a graphical user interface (GUI).

2. Discussion of the Background

A graphical user interface (GUI) is a type of computing environment in which users exchange information with computers through graphical images. Most user interfaces are based on input devices, such as a keyboard or a mouse, and thus require users to select one of a is plurality of menu items on a screen using a keyboard or a mouse to give instructions to computers.

With the advent of touch screens, various GUIs that allow users to interact with electronic devices through touch gestures without the aid of additional input devices have been developed. For example, in the case of a smart phone, various graphical icons may be displayed on the touch screen of the smart phone. In this example, a user can interact with the smart phone simply by touching any one of the graphical icons.

As the operations provided by mobile devices and the types of applications installed in mobile devices diversify, it takes more and more time for users to search for desired graphical icons. In order to address this problem, user interfaces capable of classifying a plurality of graphical icons that have, for example, similar operations into a folder and providing the folder as a favorite have been developed. However, in a case in which graphical icons are classified into one or more folders, a user may not be able to determine what graphical icons are included in each folder until opening each folder. Even if the user knows exactly where a desired graphical icon is located, the user may still need to select the folder including the desired graphical icon and then the desired graphical icon separately, which is inconvenient.

### SUMMARY

Exemplary embodiments of the present invention provide an apparatus and method for providing a graphical user interface (GUI), and more particularly to a GUI based on a shelf region for selecting and/or executing one or more graphical objects that are registered on the same display level as one or more graphical objects that are displayed on a background screen.

Additional features of the invention will be set forth in the description which follows, and in part will be apparent from the description, or may be learned by practice of the invention.

An exemplary embodiment of the present invention discloses an apparatus to provide a graphical user interface (GUI), the apparatus including: a first region display one or more graphical objects; a second region to be generated by a user setting as an M×N region; and a control unit to add one or more of the graphical objects to the second region and, in response to the number of graphical objects added to the second region being N or greater, to display the added graphical objects such that the added graphical objects can be selected, executed, or navigated by a flick or touch gesture that is made in the second region.

An exemplary embodiment of the present invention also discloses a method for providing a graphical user interface (GUI), the method including: generating a first region in which one or more graphical objects are displayed and a second region that is set as an M×N region; and adding one or more of the graphical objects to the second region, and in response to the number of graphical objects added to the second region being N or greater, displaying the added graphical objects such that the added graphical objects can be selected, executed, or navigated by a flick or touch gesture that is made in the second region.

An exemplary embodiment of the present invention also discloses an apparatus to provide a graphical user interface (GUI), the apparatus including: a display unit to display an idle screen and a shelf region that is generated on the same display level as the idle screen; and a control unit to add one or more graphical objects displayed on the idle screen to the shelf region according to a user's choice and, in response to a number of graphical objects added to the shelf region being 2 or greater, to control a graphic effect that is applied to the display unit such that is the added graphical objects can be selected, executed, or navigated by a flick or touch gesture that is made in the shelf region.

An exemplary embodiment of the present invention also discloses a method for providing a graphical user interface (GUI), the method including: generating a shelf region on the same display level as an idle screen on which one or more graphical objects are displayed; adding one or more graphical objects to the shelf region; and displaying the added graphical objects such that the added graphical objects can be selected, executed, or navigated by a flick or touch gesture that is made in the shelf region.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram of an apparatus to provide a graphical user interface (GUI) according to an exemplary embodiment.

FIG. 2 is a diagram of a display screen of a mobile device according to an exemplary embodiment.

FIG. 3 is a diagram of a display screen according to an exemplary embodiment.

FIG. 4 is a diagram of a display screen according to an exemplary embodiment.

FIG. 5A is a diagram of a display screen according to an exemplary embodiment.

FIG. 5B is a diagram of a display screen according to an exemplary embodiment.

FIG. 5C is a diagram of a display screen according to an exemplary embodiment.

FIG. 6 is a diagram of a display screen of a mobile device according to an exemplary embodiment.

FIG. 7 is a flowchart of a method of providing a graphical user interface (GUI) according to an exemplary embodiment.

### DETAILED DESCRIPTION

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of elements may be exaggerated for clarity. Like reference numerals in the drawings denote like elements. Also, descriptions of well-known operations and constructions may be omitted for increased clarity and conciseness.

It will be understood that, although the terms first, second, third etc., may be used herein to describe various elements, components, regions and/or sections, these elements, components, regions, and/or sections should not be limited by these terms. These terms are only used to distinguish one element, component, region, or section from another region, layer or section. Thus, a first element, component, region, or section discussed below could be termed a is second element, component, region, or section without departing from the teachings of the present invention.

Spatially relative terms, such as “left,” “right,” “longitudinal,” “latitudinal,” “ahead,” “behind,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “latitudinal” would then be oriented “longitudinal” the other elements or features. Thus, the exemplary term “latitudinal” can encompass both an orientation of above and below. The device may be otherwise oriented (rotated 90 degrees or at other orientations) and the spatially relative descriptors used herein interpreted accordingly.

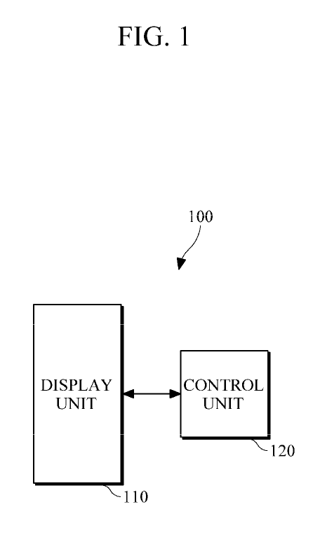

FIG. 1 is a diagram of an apparatus to provide a graphical user interface (GUI) according to an exemplary embodiment.

Referring to FIG. 1, apparatus 100 may be applied to various mobile devices. For example, the various mobile devices may include, but are not limited to, a smart phone, a mobile phone, a personal digital assistant (PDA), a portable multimedia player (PMP), and the like. A mobile device to which the apparatus 100 is applied may be controlled using one or more graphical objects. The term ‘graphical object’ refers to icons for executing applications that are installed in a mobile device, widgets showing various information that is related to the mobile device or the applications, shortcut menus corresponding to the icons or the widgets, and the like. For example, a user may use the mobile device and various applications that are installed in the mobile device by touching various graphical objects that are displayed on the touch screen of the is mobile device.

In FIG. 1, the apparatus 100 includes a display unit 110 and a control unit 120.

The display unit 110 may be a touch screen that displays various graphical objects and receives a user input. The graphical objects may be images, icons, widgets, and the like that are displayed in association with the mobile device and various applications installed in the mobile device. For example, the graphical objects may include, but are not limited to, operation icons corresponding to various operations of the mobile device, application icons corresponding to the applications installed in the mobile device, information widgets corresponding to state information of the mobile device or search information, and shortcut menus corresponding to the operation icons, the application icons, and the information widgets.

The display unit 110 may include a first region in which one or more graphical objects that can be selected are displayed and a second region that is generated by a user setting as an M×N region. In an M×N region, a maximum of M×N graphical objects may be displayed. For example, a maximum of M×N graphical objects may be displayed two-dimensionally on a basic background screen of the mobile device. The terms ‘background screen’ and ‘idle screen’ may be used interchangeably.

The control unit 120 may control a graphical effect that is applied to the display unit 110. The control unit 120 may generate and display a shelf region on the same display level as one or more graphical objects, may add one or more of the graphical objects to the shelf region, and may control the graphical effect applied to the display unit 110 such that the graphical objects added to the shelf region can be readily selected, executed, or navigated by a flick or touch gesture that is made in the shelf region. For example, the control unit 120 may add a graphical object in the first region to the second region, and may control a graphic effect that is is applied to the second region.

The term ‘flick’ refers a gesture made by placing a finger on a graphical object in the shelf region and swiping the finger quickly in an arbitrary direction. The term ‘navigation’ refers to changing the order and the manner in which the graphical objects in the second region or the shelf region are displayed or rearranging the graphical objects in the second region or the shelf region.

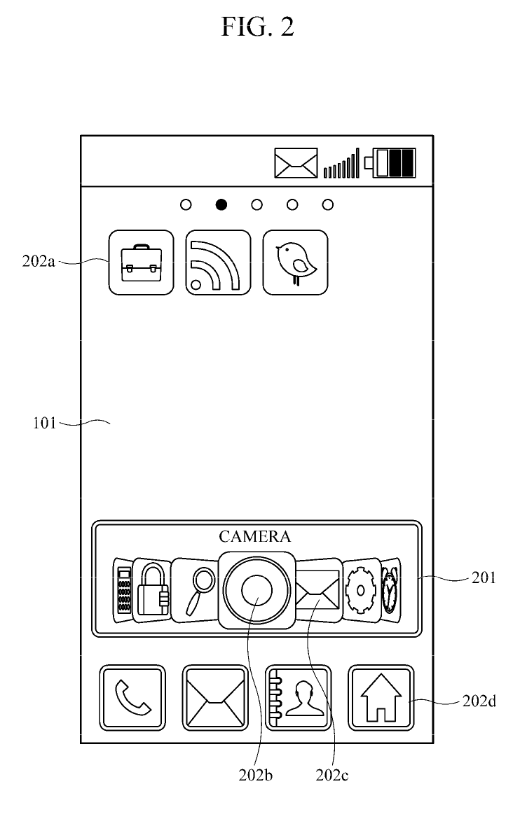

FIG. 2 is a diagram of a display screen of a mobile device according to an exemplary embodiment.

Referring to FIG. 1 and FIG. 2, the display unit 110 may include first region 101 and second region 201. The first region 101 may correspond to a basic background screen, and the second region 201 may correspond to the shelf region that is generated on the basic background screen, and that has the same display level as the basic background screen. The term ‘display level of a basic background screen’ refers to a background screen on which one or more basic graphical objects 202a are displayed, and the display level of the basic background screen may be referred to as a basic display level. For example, during the operation of the mobile device, a menu screen or an application window may pop up and may block the basic graphical objects 202a from view. In this example, the menu screen or the application window may be referred to as having a higher display level than the basic display level.

The shelf region 201 may be generated and displayed on the same display level as the basic graphical objects 202a. For example, the shelf region 201 may be displayed at the same time with the basic graphical objects 202a, and a user may view the shelf region 201 and the basic graphical objects 202a at the same time from the level of the basic background screen. The user may view one or more graphical objects that are displayed in the first region 101 and is one or more graphical objects that are displayed in the second region 201 at the same time.

The control unit 120 may generate the shelf region 201 in response to a shelf region generation request signal received from a user. For example, the shelf region generation request signal may correspond to a touch gesture that is detected from a specific graphical object, for example, a graphical object 202d. The shelf region generation request signal may correspond to a touch gesture that draws a closed curve around a specific area on the display unit 110. For example, the user may generate the shelf region 201 by touching the graphical object 202d or making a gesture of drawing a closed curve around a specific area on the display unit 110.

The control unit 120 may add a first graphical object 202b and a second graphical object 202c to the shelf region 201. For example, the control unit 120 may add the first graphical object 202b and the second graphical object 202c to the shelf region 201 in response to a graphical object addition request signal being received from the user. The graphical object addition request signal may correspond to a gesture of dragging a specific graphical object, for example, a graphical object 202a, into the shelf region 201.

The control unit 120 may appropriately arrange the first graphical object 202b and second graphical object 202c in a virtual three-dimensional (3D) space such that the first graphical object 202b and second graphical object 202c can be readily selected, executed, or navigated by a flick or touch gesture that is made in the shelf region 201.

For example, the control unit 120 may add the first graphical object 202b and second graphical object 202c to the shelf region 201, and may arrange the first graphical object 202b and second graphical object 202c three-dimensionally such that the first graphical object 202b can be displayed ahead of the second graphical object 202c and can partially block the second graphical object 202c from view. The control unit 120 may set a virtual circle whose is center lies on a vertical axis or horizontal axis of the display unit 110 in the shelf region 201, and may arrange the first graphical object 202b and second graphical object 202c with respect to the circumference of the virtual circle.

The control unit 120 may appropriately change the order and the manner in which the first graphical object 202b and second graphical object 202c are arranged in the shelf region 201 in response to a graphical object selection and/or execution request signal being received from the user.

For example, in response to the user placing a finger on the second graphical object 202c and flicking the finger to the left, the control unit 120 may display the second graphical object 202c, which was previously displayed behind the first graphical object 202b, ahead of the first graphical object 202b.

The user may register one or more graphical objects that are highly preferred, i.e., the first graphical object 202b and second graphical object 202c, in the shelf region 201, may change the position of one of the first graphical object 202b and second graphical object 202c, for example, the second graphical object 202c, from the side to the center of the shelf region 201 and may execute the second graphical object 202c.

For convenience, a graphical object that is displayed at a foremost position in the shelf region 201, i.e., the first graphical object 202b, may be located at the center of the shelf region 201, and may appear to be largest in size. The first graphical object 202b, which is located at the center of the shelf region 201, may be displayed along with its name or index information. Other graphical objects in the shelf region 201, for example, the second graphical object 202c, may be displayed to be non-foremost and smaller than the first graphical object 202b in size to improve perspective view of the graphical objects. The other graphical objects in is the shelf region 201 may be tilted toward the first graphical object 202b by a specific angle to improve perspective view of the graphical objects.

The control unit 120 may compare the number of graphical objects that are added to the shelf region 201 and the number of graphical objects that can be displayed in each row or column outside the shelf region 201, and may adjust the size of the shelf region 201 based on the results of the comparison. For example, in response to the size of an idle screen being M′×N′, the size of the shelf region 201 may be set to M×N. In an exemplary embodiment, N may be smaller than or the same as N′. For example, N may be set to a value of 2 or greater. In an exemplary embodiment, the shelf region 201 may become rectangular.

For example, if a maximum of four graphical objects can be displayed in each row of a background screen and three graphical objects or less are added to the shelf region 201, the control unit 120 may reduce the width of the shelf region 201 to be smaller than the width of each row of the background screen (i.e., the width of the display unit 110). For example, the shelf region 201 may be displayed in a longitudinal direction of the display unit 110 or in a latitudinal direction of the display unit 110.

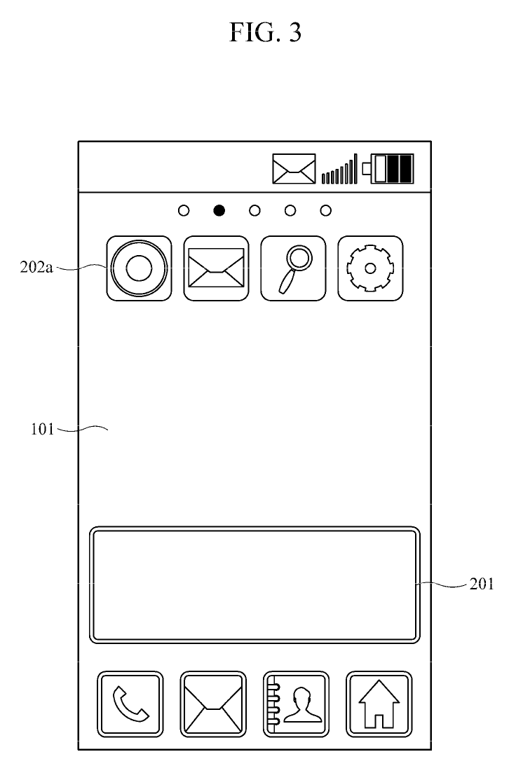

FIG. 3 is a diagram of a display screen according to an exemplary embodiment. FIG. 3 illustrates an example of a display screen for generating a shelf region.

Referring to FIG. 3, a plurality of icons 202a are displayed on an idle screen of the display unit 110. For example, the icons 202a may be icons for executing applications. The icons 202a may be displayed on a basic display level, which is one of the display levels of the display unit 110. The basic display level may correspond to a background screen that is displayed as a default screen if no application is executed.

The shelf region 201 may be displayed on the same display level as the icons 202a, i.e., the basic display level. In other words, the shelf region 201 may be displayed on the background screen at the same time with the icons 202a.

The shelf region 201 may be generated by double-touching a specific icon for generating the shelf region 201 or making a gesture of drawing a closed curve in a region where no icons 202a are displayed.

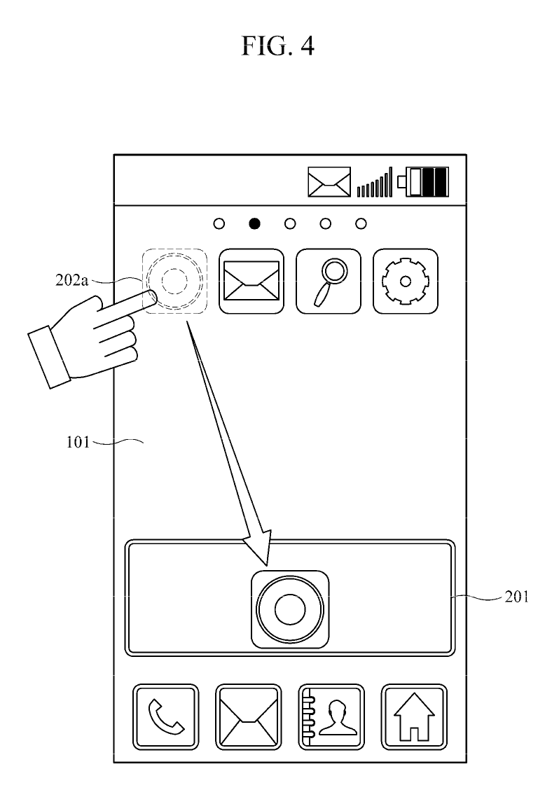

FIG. 4 is a diagram of a display screen according to an exemplary embodiment. FIG. 4 illustrates adding an icon to a shelf region.

Referring to FIG. 3 and FIG. 4, a shelf region 201 and a plurality of icons 202a may be displayed on the same display level, and the icons 202a may be added to the shelf region 201 by a drag gesture. For example, as a result of the drag gesture, the icons 202a may be moved into the shelf region 201. In an exemplary embodiment, the icons 202a may stay where they were before the drag gesture.

A user may add a plurality of icons to the shelf region 201. For example, the user may drag each of the icons 202a into the shelf region 201. As another example, the user may designate one or more icons 202a as a group and drag the group into the shelf region 201.

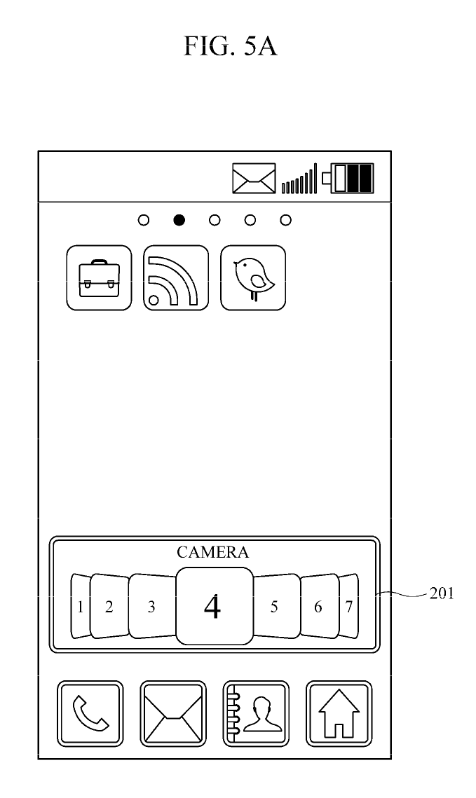

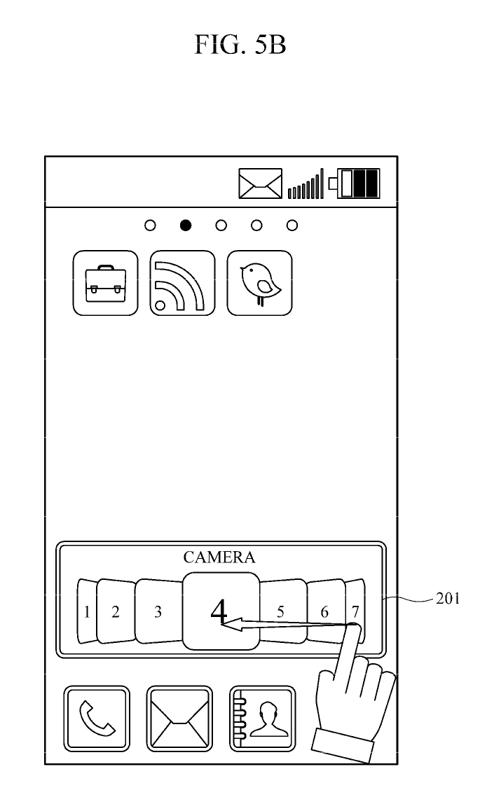

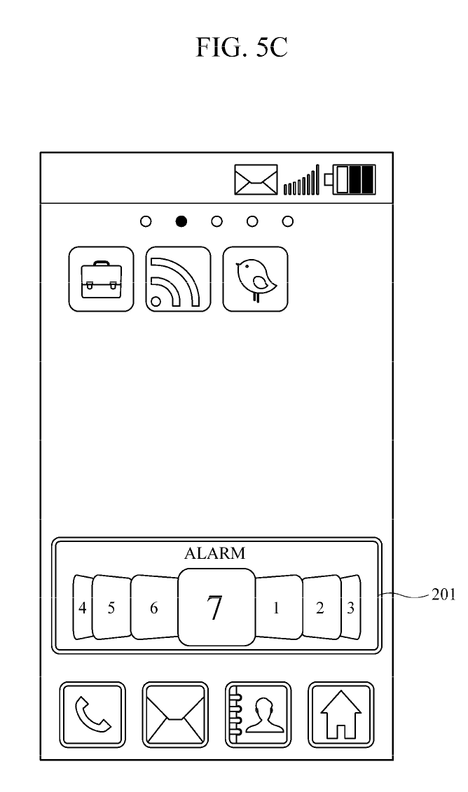

FIG. 5A is a diagram of a display screen according to an exemplary embodiment. FIG. 5B is a diagram of a display screen according to an exemplary embodiment. FIG. 5C is a diagram of a display screen according to an exemplary embodiment. FIG. 5A through FIG. 5C to illustrate examples of display screens for arranging and displaying one or more icons in a shelf region.

Referring to FIG. 5A, seven basic icons (i.e., first icon, second icon, third icon, fourth icon, fifth icon, sixth icon and seventh icon) may be added to a shelf region 201. For example, the seven basic icons may include icons for executing applications and various is graphical objects such as widgets, shortcut menus and the like.

The seven basic icons may be displayed in the shelf region 201 in the order in which the seven basic icons are added to the shelf region 201. For example, if the fourth icon is added to the shelf region 201 first, the fourth icon may be displayed at the center of the shelf region 201. If the fifth icon is added to the shelf region 201 by being dragged into the shelf region 201 after the addition of the fourth icon, the fifth icon may be displayed behind the right side of the fourth icon in a smaller size than the fourth icon. If the third icon is added to the shelf region 201 by being dragged into the shelf region 201 after the addition of the fifth icon, the third icon may be displayed behind the left side of the fourth icon in a smaller size than the fourth icon. The seven basic icons may be displayed in the shelf region 201 three-dimensionally in the order in which the seven basic icons are added to the shelf region 201. The amount by which a pair of adjacent icons overlaps each other in the shelf region 201 may be determined by the number of icons that are added to the shelf region 201.

A user may select and execute one of the seven basic icons through a flick gesture, as shown in FIG. 5B.

For example, referring to FIG. 5B, a user may select the seventh icon by placing a finger on the seventh icon and swiping the finger toward the center of the shelf region 201. In an exemplary embodiment, the user may select the seventh icon by placing a finger on the seventh icon and dragging the finger to the center of the shelf region 201.

In response to the seventh icon being selected, as shown in FIG. 5B, the first through seventh icons may be rearranged in the shelf region 201, as shown in FIG. 5C.

Referring to FIG. 5C, the seventh icon may be displayed at a foremost position at the center of the shelf region 201. For example, assuming that there is a virtual central axis that is vertically penetrates the display unit 110, one or more virtual circles whose center lies on the virtual central axis may be set, and the first through seventh icons may be rearranged along the circumferences of the virtual circles. Accordingly, the third icon may be displayed in a position where the seventh icon was previously displayed.

Referring to FIG. 3, FIG. 4, and FIG. 5, one or more preferred icons may be added to the shelf region, which is displayed on the same display level as the icons 202a, and may be readily selected and executed in the shelf region 201. Accordingly, it may be possible to provide an efficient and intuitive GUI.

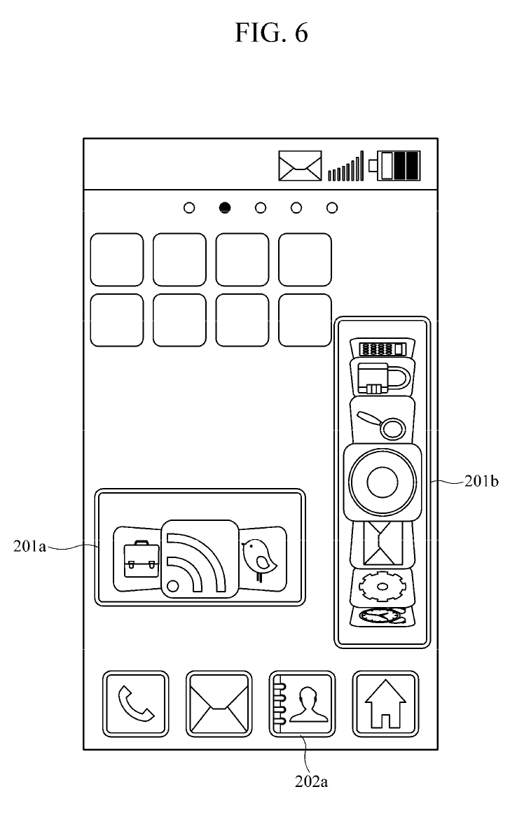

FIG. 6 is a diagram of a display screen of a mobile device according to an exemplary embodiment.

Referring to FIG. 1 and FIG. 6, the control unit 120 may generate a plurality of shelf regions (for example, first shelf region 201a and second shelf region 201b) that are displayed on a basic display level of the display unit 110. The first shelf region 201a and second shelf region 202b may be displayed on the basic display level together with one or more basic graphical objects 202a. Accordingly, a viewer may view the first shelf region 201a and second shelf region 201b and the basic graphical objects 202a at the same time from the basic display level.

The first shelf region 201a and second shelf region 201b may be set to have different sizes and to be displayed at different locations. For example, if three icons are added the first shelf region 201a, the first shelf region 201a may be set to be smaller than the second shelf region 201b. For example, if up to four icons can be displayed in each row of a background screen of the display unit 110 and four or more icons are added to the first shelf region 201a, the size of the first shelf region 201a may be set to be the same as the width of the is background screen. For example, if less than four icons are added to the first shelf region 201a even though a maximum of four icons can be displayed in each row of the background screen, the size of the first shelf region 201a may be set to be smaller than the width of the width of the background screen. For example, the size of the first shelf region 201a may be adjusted by making a touch gesture on either side of the first shelf region 201a.

The second shelf region 201b may be displayed along a longitudinal direction of the display unit 110. The icons in the first shelf region 201a, which is displayed along a latitudinal direction of the display unit 110, may be rotated with respect to a vertical central axis that corresponds to the longitudinal direction of the display unit 110. In other words, the icons in the first shelf region 201a may be positioned parallel to the short side of the display unit 110 and may be rotated about a central axis perpendicular to the short side of the display unit 110. The icons in the second shelf region 201b may be rotated with respect to a virtual central axis that corresponds to the latitudinal direction of the display unit 110. In other words, the icons in the second shelf region 201b may be positioned parallel to the long side of the display unit 110 and may be rotated about a central axis perpendicular to the long side of the display unit 110. Accordingly, it is possible to select and execute any one of the icons in the first shelf region 201a by moving a finger horizontally inside the first shelf region 201a. In addition, it is possible to select and execute any one of the icons in the second shelf region 201b by moving a finger vertically inside the first shelf region 201a.

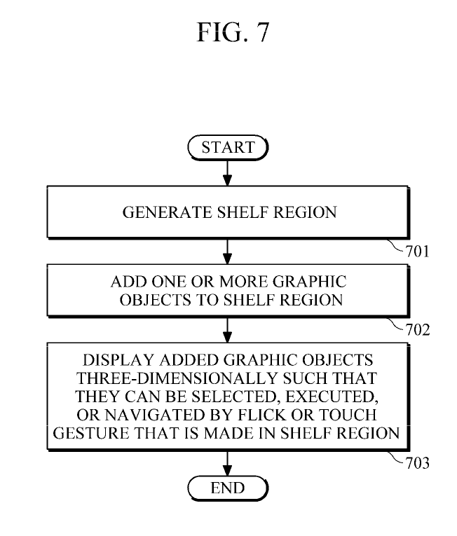

FIG. 7 is a flowchart of a method of providing a graphical user interface (GUI) according to an exemplary embodiment.

Referring to FIGS. 1 and 7, in operation 701, the apparatus 100 may generate a shelf region on the display unit 110. The shelf region may correspond to a specific region on the is display unit 110 in which one or more graphical objects are registered. For example, referring to FIG. 3, the control unit 120 may generate a shelf region 201 on a basic background screen of the display unit 110.

In operation 702, the apparatus 100 may add one or more of the graphical objects to the shelf region. For example, referring to FIG. 4, the control unit 120 may add a plurality of icons to the shelf region 201.

In operation 703, the apparatus 100 may display the graphical objects added to the shelf region three-dimensionally such that the graphical objects can be readily selected, executed, or navigated by a flick or touch gesture that is made in the shelf region. For example, referring to FIG. 5A, the control unit 120 may arrange one or more graphical objects in the shelf region in the order in which the one or more graphical objects are added to the shelf region, and may display them to partially overlap one another to achieve perspective view of the one or more graphical objects. For example, referring to FIG. 5B and FIG. 5C, the control unit 120 may rearrange the graphical objects in the shelf region three-dimensionally in response to a user input being received.

As described above, it is possible to effectively control a mobile device using the shelf region without the need to switch from one display level to another display level since a shelf region is displayed on the same display level as a basic background screen. In addition, since one or more graphical objects that are added to the shelf region can be rearranged intuitively, it is possible to provide an efficient GUI.

The processes, functions, methods, and/or software described herein may be recorded, stored, or fixed in one or more non-transitory computer-readable storage media that includes program instructions to be implemented by a computer to cause a processor to execute is or perform the program instructions. The non-transitory media may also include, alone or in combination with the program instructions, data files, data structures, and the like. The media and program instructions may be those specially designed and constructed, or they may be of the kind well-known and available to those having skill in the computer software arts. Examples of non-transitory computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more non-transitory computer-readable storage media, in order to perform the operations and methods described above, or vice versa. In addition, a non-transitory computer-readable storage medium may be distributed among computer systems connected through a network and computer-readable codes or program instructions may be stored and executed in a decentralized manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to provide a graphical user interface (GUI), the apparatus comprising:
a first region to display one or more graphical objects;
a second region to be generated by a user setting as an M×N region; and
a control unit to add one or more of the graphical objects to the second region and, in response to the number of graphical objects added to the second region being N or greater, to display the added graphical objects such that the added graphical objects can be selected, executed, or navigated by a flick or touch gesture that is made in the second region.

2. The apparatus of claim 1, wherein the second region is displayed or generated on an M′×N′ idle screen.

3. The apparatus of claim 2, wherein N′ is greater than or equal to N.

4. The apparatus of claim 1, wherein the graphical objects are displayed on an idle screen or a menu screen.

5. The apparatus of claim 1, wherein the added graphical objects are displayed as being tilted toward a center of the second region by a specific angle.

6. The apparatus of claim 1, wherein a graphical object that is displayed at a center of the second region is accompanied by index information.

7. The apparatus of claim 1, wherein the added graphical objects are displayed three-dimensionally such that a graphical object distant from a center of the second region can be displayed relatively behind a graphical object less distant from the center of the second region.

8. The apparatus of claim 1, wherein N is 2 or greater and the second region is generated as a rectangular region.

9. The apparatus of claim 1, wherein the added graphical objects are rotated with respect to a central axis parallel to a long side of the second region.

10. A method for providing a graphical user interface (GUI), the method comprising:
generating a first region in which one or more graphical objects are displayed and a second region that is set as an M×N region; and
adding one or more of the graphical objects to the second region, and in response to the number of graphical objects added to the second region being N or greater, displaying the added graphical objects such that the added graphical objects can be selected, executed, or navigated by a flick or touch gesture that is made in the second region.

11. The method of claim 10, wherein the second region is displayed or generated on an M′×N′ idle screen.

12. The method of claim 11, wherein N′ is greater than or equal to N.

13. The method of claim 10, wherein the graphical objects are displayed on an idle screen or a menu screen.

14. The method of claim 10, wherein the added graphical objects are displayed as being tilted toward a center of the second region by a specific angle.

15. The method of claim 10, wherein a graphical object that is displayed at a center of the second region is accompanied by index information.

16. The method of claim 10, wherein the added graphical objects are displayed three-dimensionally such that a graphical object distant from a center of the second region can be displayed relatively behind a graphical object less distant from the center of the second region.

17. The method of claim 10, wherein N is 2 or greater and the second region is generated as a rectangular region.

18. The method of claim 10, wherein the added graphical objects are rotated with respect to a central axis parallel to a long side of the second region.

19. An apparatus to provide a graphical user interface (GUI), the apparatus comprising:
a display unit to display an idle screen and a shelf region that is generated on the same display level as the idle screen; and
a control unit to add one or more graphical objects displayed on the idle screen to the shelf region according to a user's choice and, in response to a number of graphical objects added to the shelf region being 2 or greater, to control a graphic effect that is applied to the display unit such that the added graphical objects can be selected, executed, or navigated by a flick or touch gesture that is made in the shelf region.

20. The apparatus of claim 19, wherein the control unit adds a first graphical object and a second graphical object to the shelf region and arranges the first graphical object and the second graphical object three-dimensionally such that the second graphical object can be displayed relatively behind the first graphical object and can be partially blocked from view by the first graphical object.

21. The apparatus of claim 20, wherein the control unit, in response to a user input, rearranges the first graphical object and the second graphical object such that the second graphical object can be displayed relatively in front of the first graphical object.

22. The apparatus of claim 19, wherein the control unit displays a graphical object that is located at a foremost position in the shelf region at a center of the shelf region and displays other non-foremost graphical objects around the foremost graphical object.

23. The apparatus of claim 22, wherein the control unit displays the foremost graphical object with index information.

24. The apparatus of claim 22, wherein the non-foremost graphical objects are displayed as being tilted toward the foremost graphical object by a specific angle.

25. The apparatus of claim 19, wherein the control unit compares the number of graphical objects added to the shelf region and the number of graphical objects that can be displayed on the idle screen and adjusts the size of the shelf region based on the results of the comparison.

26. The apparatus of claim 19, wherein the control unit sets one or more virtual circles whose center lies on a vertical axis or horizontal axis of the display unit in the shelf region and arranges the added graphical objects along the circumferences of the virtual circles.

27. The apparatus of claim 19, wherein the added graphical objects and the graphical objects displayed on the idle screen can be displayed at the same time.

28. A method for providing a graphical user interface (GUI), the method comprising:
generating a shelf region on the same display level as an idle screen on which one or more graphical objects are displayed;
adding one or more graphical objects to the shelf region; and
displaying the added graphical objects such that the added graphical objects can be selected, executed, or navigated by a flick or touch gesture that is made in the shelf region.

29. The method of claim 28, wherein the displaying the added graphical objects comprises arranging a first graphical object and a second graphical object, from among the added graphical objects, three-dimensionally such that the second graphical object can be displayed relatively behind the first graphical object and can be partially blocked from view by the first graphical object

30. The method of claim 29, wherein the displaying the added graphical objects further comprises, in response to a user input, rearranging the first graphical object and the second graphical object three-dimensionally such that the second graphical object can be displayed relatively in front of the first graphical object.

31. The method of claim 29, wherein the displaying the added graphical objects further comprises displaying a graphical object that is located at a foremost position in the shelf region at a center of the shelf region and displaying other non-foremost graphical objects around the foremost graphical object.

32. The method of claim 31, wherein the displaying the added graphical objects further comprises displaying the non-foremost graphical objects as being tilted toward the foremost graphical object by a specific angle.

33. The method of claim 28, wherein the displaying the added graphical objects comprises comparing the number of graphical objects added to the shelf region and the number of graphical objects that can be displayed on the idle screen and adjusting the size of the shelf region based on the results of the comparison.

34. The method of claim 28, wherein the displaying the added graphical objects comprises setting one or more virtual circles whose center lies on a vertical axis or horizontal axis of the display unit in the shelf region and arranging the added graphical objects along the circumferences of the virtual circles.
